(19) United States
(12) Patent Application Publication
(10) Pub. No.: US 2015/0373217 A1
(43) Pub. Date: Dec. 24, 2015

(54) PAPER FEEDING FOR AN IMAGING SYSTEM

(71) Applicant: HEWLETT-PACKARD DEVELOPMENT COMPANY, L.P., Houston, TX (US)

(72) Inventors: Ronald Michael DOMBROWSKI, Boise, ID (US); Michael A. Stauffer, Boise, ID (US)

(73) Assignee: HEWLETT-PACKARD DEVELOPMENT COMPANY, L.P., Houston, TX (US)

(21) Appl. No.: 14/766,103

(22) PCT Filed: Feb. 13, 2013
(86) PCT No.: PCT/US13/25841

§ 371 Date: Aug. 5, 2015

(51) Int. Cl. H04N 1/00

(52) U.S. Cl. CPC H04N 1/00588; H04N 1/00625; H04N 1/00631; H04N 2201/0094

(57) ABSTRACT

A system and method for feeding pages in an ADF is disclosed. The system comprises an input tray, a paper picking system and a combined output tray/image platen. The paper picking system is coupled to the input tray and picks pages from a stack of pages loaded into the input tray. The paper picking system feeds the pages in sequence into the combined output tray/image platen. The pages are stacked into the combined output tray/image platen with the first page stacked on the bottom of the stack. An image of the top side of each page can be captured after the page has been stacked into the combined output tray/image platen before the next page is stacked on top.

### BACKGROUND

Multifunction peripherals (MFP) typically use flatbed scanners as the imaging device. A new style of a multifunction peripheral uses a downward facing camera aimed at an image platen on top of the MFP as the imaging device. This allows the MFP to capture images of documents as well as three-dimensional objects placed on the image platen.

### BRIEF DESCRIPTION OF THE DRAWINGS

FIG. 1 is a front view of an example multifunction peripheral (MFP).

FIG. 2 is an example block diagram of an automatic document feeder (ADF).

FIG. 3 is an example block diagram of an ADF.

FIG. 4 is a flow chart for a method for feeding pages in an automatic document feeder (ADF).

### DETAILED DESCRIPTION

A multifunction peripheral (MFP) is a device that typically contains a printer and an imaging system, typically a scanner. The MFP can be used as a printer, a scanner, a copier, a facsimile machine (FAX) or the like. MFPs are also called all-in-one devices (AiO), multifunction devices, multifunction printers or the like. A new type of multifunction peripheral (MFP) uses a downward facing camera system aimed at an image platen on top of the MFP as the scanning device. The downward facing camera system allows a user to scan a page of a document or a three-dimensional object placed on the image platen. Many documents have multiple pages. Without an automatic document feeder (ADF), the user has to manually place each page of the document onto the image platen while the camera system captures an image. Conventional ADFs do not work with the downward viewing camera systems.

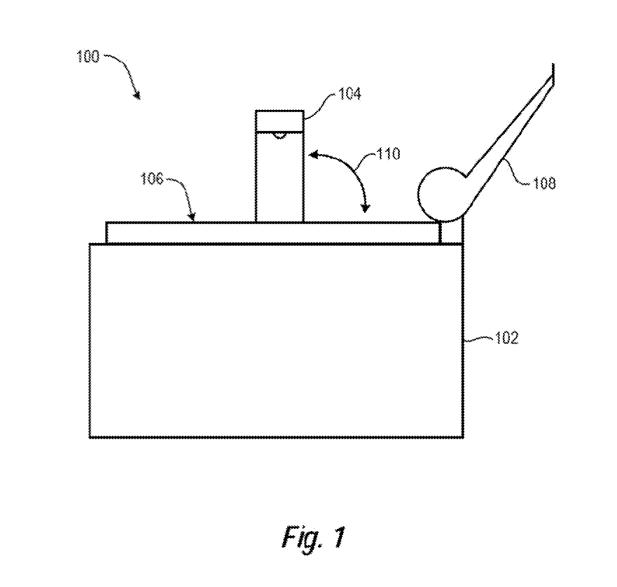

In one example an ADF with a combined output tray/image platen is provided for an MFP that uses a downward facing camera system. FIG. 1 is a front view of an example MFP. MFP 100 comprises a printer 102, a downward viewing camera system 104 and an ADF 108 with a combined output tray/image platen 106. Printer 102 may be any type of conventional printer, for example a LaserJet printer or an inkjet printer. The downward viewing camera system is used as the imaging system for the MFP. The downward viewing camera system may be coupled to the printer by an arm that can be rotated from a capture position to a storage position (as shown by arrow 110). When the downward viewing camera system is in the capture position (as shown), one or more image sensors are positioned to capture images of the surface of the combined output tray/image platen 106. The downward viewing camera system 104 may contain one or more light sources to illuminate the top surface of the combined output tray/image platen 106.

An image platen is defined as the location where images are captured using the imaging system. In this example the imaging system is the downward viewing camera system. Because the imaging system is a downward viewing camera system, images can be captured from documents and three-dimensional objects placed on the image platen. An output tray is defined as the location where pages are stacked after the page has been fed through an ADF. The combined output tray/image platen 106 functions as both the imaging platen as well as the location where pages are stacked after being fed through the ADF.

ADF 108 is coupled to printer 102 and can feed a stack of pages into combined output tray/image platen 106. In one example ADF 108 may be removably coupled to the MFP such that the ADF can be purchased as an accessory. In other examples ADF 108 may be integrated as part of MFP 100.

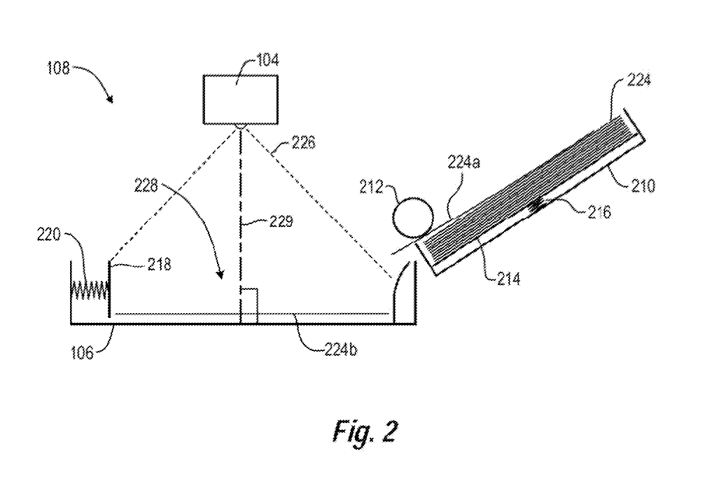

FIG. 2 is an example block diagram of an ADF 108. ADF 108 comprises input tray 210, combined output tray/image platen 106 and a paper picking system. Paper picking system may comprise one or more paper pickers 212 and a bottom plate 214 that is biased towards the paper pickers 212 by spring 216. Paper picking system may also comprise one or more separator drums, pinch rollers, sensors, motors and the like, but these items are not shown for clarity. Paper picking system is designed to pick a variety of page types from input tray, for example paper, velum, transparent media and the like.

Input tray is shown loaded with a stack of pages 224. Paper picking system picks the top page 224a from the stack of pages 224 and feeds it into the combined output tray/image platen 106. Combined output tray/image platen 106 is positioned under downward viewing camera system 104. Downward viewing camera system 104 can capture images of objects placed in output tray 106 (as shown by imaging area 226). Downward viewing camera system 104 has an optical axis 229. Optical axis is set perpendicular to the top surface of combined output tray/image platen 106. Page 224b is shown already loaded into combined output tray/image platen 106 in a page stacking location. In one example, combined output tray/image platen 106 may have a spring 220 loaded biasing device 218 that aligns the pages in the output tray against one or more edges of the output tray that may define the page stacking location. The top surface of combined output tray/image platen 106 is open. This allows access for a user to place three-dimensional objects or single pages of a document onto the combined output tray/image platen 106 (as shown by arrow 228). This also allows a user to remove stacks of pages after they have been loaded into the combined output tray/image platen 106.

In operation a user loads a stack of pages into the input tray face-up. The ADF picks the top page in the stack and feed it into the combined output tray/image platen 106 face up. The downward viewing camera system 104 captures an image of the page in the combined output tray/image platen 106. The ADF then feeds the next page from the input tray onto the top of the page already located in the combined output tray/image platen 106. By placing the pages face up on top of each other in the combined output tray/image platen 106, the downward viewing camera system 104 can capture an image of each page after it has been loaded into the combined output tray/image platen. Because output tray and image platen are combined, the pages do not need to be moved from the image platen/output tray after the camera system takes an image of the page.

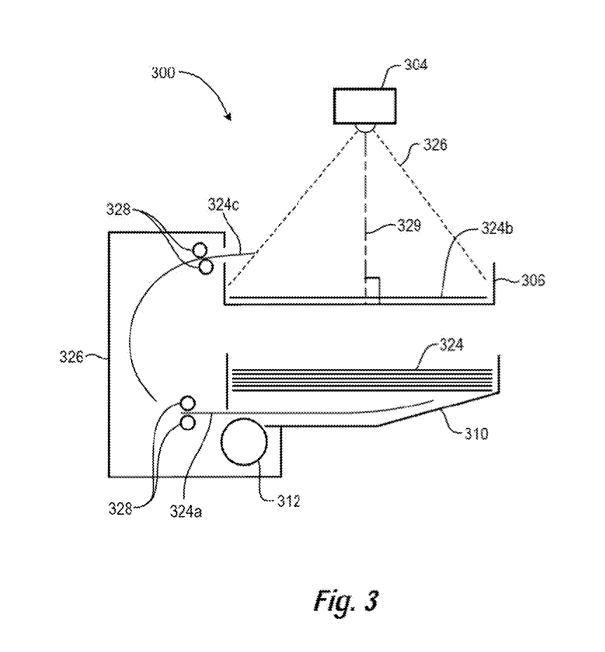

FIG. 3 is an example block diagram of ADF 300. ADF 300 comprises an input tray 310, a combined output tray/image platen 306, a housing 326 and a paper picking system. ADF 300 is positioned under a downward viewing camera system 304. Downward viewing camera system 304 has a viewing field 326 and an optical axis 329. Viewing field 326 is directed towards the top surface of combined output tray/image platen 306. Optical axis is perpendicular to the top surface of combined output tray/image platen 306. Input tray is arranged to hold a stack of pages 324 loaded face down into the input tray 310. Paper picking system is located inside housing 326 and comprises picker. 312, two pair of pinch rollers 328 and a paper path (shown by page 324c). Paper picking system may also comprise one or more separator drums, sensors, motors and the like, but these items are not shown for clarity. Paper picking system is designed to pick a variety of page types from input tray, for example paper, velum, transparent media and the like.

Paper picking system is coupled to the bottom side of input tray 310. Paper picking system picks pages from the bottom of the stack of pages 324 and feeds them in sequence into combined output tray/image platen 306. Page 324a is shown being picked from the bottom of the stack of pages 324. Page 324c is shown in the paper path as the page 324c is being fed into the combined output tray/image platen 306. The paper path causes pages that were placed face down into the input tray 310 to be placed face up into the combined output tray/image platen 306. Page 324b has already been fed into the combined output tray/image platen 306. In some examples, combined output tray/image platen may have a biasing device to bias the pages in the combined output tray/image platen 306 against one or more sides of the combined output tray/image platen (see FIG. 2).

In operation a user loads a stack of pages into the input tray face-down. The ADF picks the bottom page in the stack and feeds it into the combined output tray/image platen 106 face up. The downward viewing camera system 104 captures an image of the page in the combined output tray/image platen 106. The ADF then feeds the next page from the input tray onto the top of the page already located in the combined output tray/image platen 106. By placing the pages face up on top of each other in the combined output tray/image platen 106, the downward viewing camera system 104 can capture an image of each page after it has been loaded into the combined output tray/image platen. Because output tray and image platen are combined, the pages do not need to be moved from the image platen/output tray after the camera system takes an image of the page.

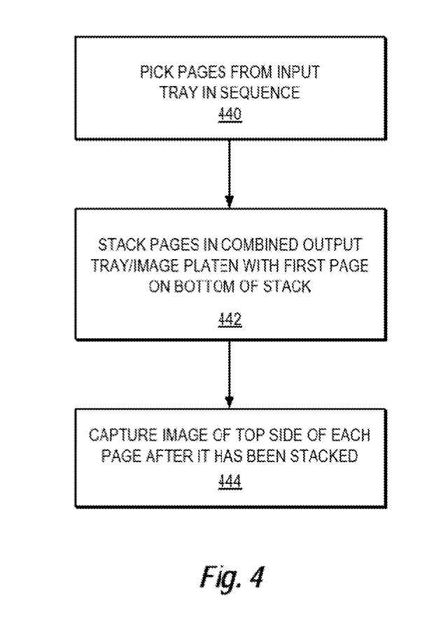

FIG. 4 is a flow chart for a method for feeding pages in an automatic document feeder (ADF). The method starts at box 440 where pages are picked from the input tray in sequence. Flow then proceeds to box 442. At 442 the pages are stacked in a combined output tray/image platen in sequence with the first page from the input tray placed on the bottom of the stack in the combined output tray/image platen. The pages are stacked in the combined output tray/image platen with the image side of the page facing upward. Flow then proceeds to box 444. At 444 an image is captured of the image side of each page after it has been stacked into the combined output tray/image platen.

What is claimed is:

1. A multifunctional peripheral, comprising:
a printer;
a downward viewing imaging system coupled to the printer and positioned above the printer;
an automatic document feeder (ADF) comprising:
a combined output tray/image platen, the combined output tray/image platen having a page stacking location, the combined output tray/image platen located on a top side of the printer and positioned underneath, and viewable by, the downward viewing imaging system;
an input tray;
a paper path;
a paper picking system coupled to the input tray to pick pages from a stack of pages loaded in the input tray and feed the pages into the paper path, one after another in sequence;
the paper path coupled to the combined output tray/image platen such that the pages are stacked into the combined output tray/image platen in sequence with an image side of each page facing upward and with a first page picked from the input tray placed on the bottom of the stack in the combined output tray/image platen.

2. The multifunctional peripheral of claim 1, where a top surface of the stacking location is perpendicular with an optical axis of the downward viewing imaging system.

3. The multifunctional peripheral of claim 1, where the input tray is located to one side of the combined output tray/image platen.

4. The multifunctional peripheral of claim 1, where the input tray is located underneath the combined output tray/image platen.

5. The multifunctional peripheral of claim 1, where the input tray is to receive the stack of paper image side up.

6. The multifunctional peripheral of claim 1, where the ADF is removably attached to the multifunctional peripheral.

7. The multifunctional peripheral of claim 1, where the printer is a LaserJet printer.

8. The multifunctional peripheral of claim 1, where the downward viewing image system can capture images of three-dimensional objects placed in the combined output tray/image platen.

9. An automatic document feeder (ADF), comprising:
an input tray;
a paper path;
a paper picking system coupled to the input tray to pick pages from a stack of pages loaded in the input tray and feed the pages into the paper path, one after another in sequence;
a combined output tray/image platen, the combined output tray/image platen having a page stacking location;
the page stacking location facing a downward viewing imaging system when the ADF is mounted to an imaging device;
the paper path coupled to the combined output tray/image platen such that the pages are stacked into the combined output tray/image platen in sequence with an image side of each page facing upward and with a first page picked from the input tray placed on the bottom of the stack in the combined output tray/image platen.

10. A method for feeding pages in an ADF, comprising
picking pages in sequence from a stack of pages in an input tray;
stacking the pages in sequence into a combined output tray/image platen with a first side of each page facing upward and where a first page from the input tray is placed on a bottom of the stack of pages in the combined output tray/image platen;
capturing an image of the first side of each page after it has been stacked into the combined output tray/image platen before a next page is stacked on top.

11. The method of claim 10, where the image of each page is captured using a downward facing camera system.

12. The method of claim 11, where the downward viewing image system can capture images of three-dimensional objects placed in the combined output tray/image platen.
